(19) United States
(12) Patent Application Publication
(10) Pub. No.: US 2007/0121457 A1
(43) Pub. Date: May 31, 2007

(54) Optical disc apparatus and optical disc recording method

(76) Inventors: Atsushi Yamada, Saitama (JP); Koichiro Nishimura, Yokohama (JP); Toru Kawashima, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/495,581

(22) Filed: Jul. 31, 2006

(30) Foreign Application Priority Data
Nov. 29, 2005 (JP) 2005-343300

(51) Int. Cl. G11B 27/36

(52) U.S. Cl. 369/53.32

(57) ABSTRACT

The present invention determines accurately whether trial write processing is necessary or not and eliminates unnecessary trial write processing to prevent the degradation of the data transfer rate. A control circuit, if an error is detected during reproduction of recorded data, compares a top value Vtop of an envelope of a reproduced signal with a predefined threshold value Vth for defect detection. As a result of comparison, if Vtop>Vth, trial write processing is performed; and if Vtop<Vth, trial write processing is not performed. The level of the threshold value Vth is set between time-mean level at an envelope's top value and that at an envelope's bottom value.

### CLAIM OF PRIORITY

The present application claims priority from Japanese application serial No. JP 2005-343300, filed on Nov. 29, 2005, the content of which is hereby incorporated by reference into this application.

### BACKGROUND OF THE INVENTION

1. Field of the Invention

The present invention relates to an optical disc apparatus and optical disc recording method for efficiently performing trial write operation when data is recorded on an optical disc.

2. Description of the Related Art

Conventionally, when data is recorded on an optical disc, the recorded data is reproduced immediately after recording to check whether the data has been recorded correctly (verify operation). If the data can be read correctly, it is determined that the recording operation has been performed correctly; otherwise (if an error occurs), retry processing (re-recording) is performed. In the retry processing, trial write processing is performed as required for optimization of recording conditions. In the trial write operation, a test signal is recorded with laser power variations at the time of recording and then such a recording power (optimum value) that the reproduction quality of the signal becomes a target value is obtained and reset.

In connection with conditions for retry processing and trial write processing, Japanese Patent Laid-open No. Hei 11-154330 describes that, if the recording quality is determined to be abnormal, search for the value of an optimum recording power is performed using a lower-limit value as the initial value to suppress the degradation of the recording surface by high-power recording. Japanese Patent Laid-open No. 2000-298833 describes a technique in which recorded data is read, it is determined whether the laser power is appropriate or not depending on whether the asymmetry value or amplitude value of the signal waveform is within a specified range or not and, if it is determined to be inappropriate, retry operation is performed with recording laser power variations.

### SUMMARY OF THE INVENTION

The trial write processing performed as part of the above-mentioned retry processing takes considerable time because a test signal is actually recorded with recording level variations and then reproduced. If trial write processing is performed during data recording, the transfer rate of recording data may be degraded, resulting in failure in real-time data recording, etc. Therefore, trial write processing should be minimized as possible. For example, if an error occurs because of a defective disc, it is meaningless and unnecessary to obtain an optimum recording power through trial write processing because there is no problem in the recording power setting. For this reason, it is necessary to determine more accurately whether trial write processing is necessary or not.

Each of the above-mentioned patent gazette describes that retry operation or trial write processing is performed if the recording quality, asymmetry, or amplitude value is found to be abnormal, and does not particularly take into account a case when trial write processing is not necessary, such as a defective disc.

An object of the present invention is to determine more accurately whether trial write processing is necessary or not to eliminate unnecessary trial write processing thus providing an optical disc apparatus and optical disc recording method which prevent the degradation of the data transfer rate.

An optical disc apparatus according to the present invention comprises an optical head which records data by irradiating an optical disc with laser light and reproduces data from the optical disc; a signal detector circuit which obtains an envelope of the data reproduced by the optical head; and a control circuit which controls the trial write processing for optimization of a recording power based on the shape of the envelope obtained by the signal detector circuit. The control circuit, if an error is detected during reproduction of recorded data, obtains an envelope of the signal reproduced by the signal detector circuit. If there is a defective portion in the envelope, where almost no signal exists or the amplitude value is attenuated more than a specified value, the control circuit performs retry recording or alternate recording of the data containing a detected error without performing trial write processing.

With an optical disc apparatus according to the present invention, if an error is detected during reproduction of recorded data, the control circuit compares a top level Vtop of the envelope of the reproduced signal with a predefined threshold value Vth. As a result of comparison, if Vtop>Vth, the control circuit performs trial write processing; and if Vtop<Vth, the control circuit does not perform the trial write processing. The level of the threshold value Vth is set between time-mean level at an envelope's top value and that at an envelope's bottom value.

Furthermore, an optical disc recording method according to the present invention, if an error is detected during reproduction of recorded data, obtains an envelope of the reproduced signal. If there is a defective portion in the envelope, where almost no signal exists, the optical disc recording method performs retry recording or alternate recording of the data containing a detected error without performing trial write processing for optimization of a recording power.

In accordance with the present invention, unnecessary trial write processing is eliminated and the degradation of the data transfer rate can be prevented, thereby improving the user convenience.

### BRIEF DESCRIPTION OF THE DRAWINGS

Theses and other features, objects and advantages of the present invention will become more apparent from the following description when taken in conjunction with the accompanying drawings:

FIG. 1 is a block diagram showing one embodiment of an optical disc apparatus according to the present invention;

FIG. 2 is a diagram showing the configuration of an envelope detector circuit according to the present embodiment;

FIG. 3A to FIG. 3C are diagrams showing a defect detection method for envelope waveform of a reproduction signal; and

FIG. 4 is a flow chart showing the procedure of recording processing according to the present embodiment.

### DETAILED DESCRIPTION OF THE PREFERRED EMBODIMENT

FIG. 1 is a block diagram showing one embodiment of an optical disc apparatus according to the present invention. The apparatus of the present embodiment rotates a recordable optical disc 1 with a spindle motor 3, and irradiates the recording surface of the optical disc 1 from an optical head 2 with laser light generated by a semiconductor laser to record and reproduce data. A motor driver circuit 4 controls the rotational operation of the spindle motor 3. The light emitting power of the semiconductor laser at the time of recording is controlled by a laser driver circuit 5. A reproduction processing circuit 6 processes data reproduced from the optical disc. A defect detector circuit (signal detector circuit) 7 obtains an envelope of the reproduction signal and detects a disc defect, etc. A power control circuit 8 generates a test signal (recording power variable signal) when performing trial write processing. A control circuit 9 performs judgments of trial write processing, retry recording processing, alternate recording processing, and etc. and control of the entire apparatus.

In accordance with the present embodiment, in verify processing, i.e., during reproduction of recorded data immediately after recording, if an error is detected, the envelope shape of the reproduction signal is measured by the defect detector circuit (signal detector circuit) 7 and a disc defect is determined by detecting an envelope defect. The control circuit 9, if a disc defect is determined, performs control so as to proceed to retry recording processing or alternate processing of the data containing a detected error without performing trial write processing.

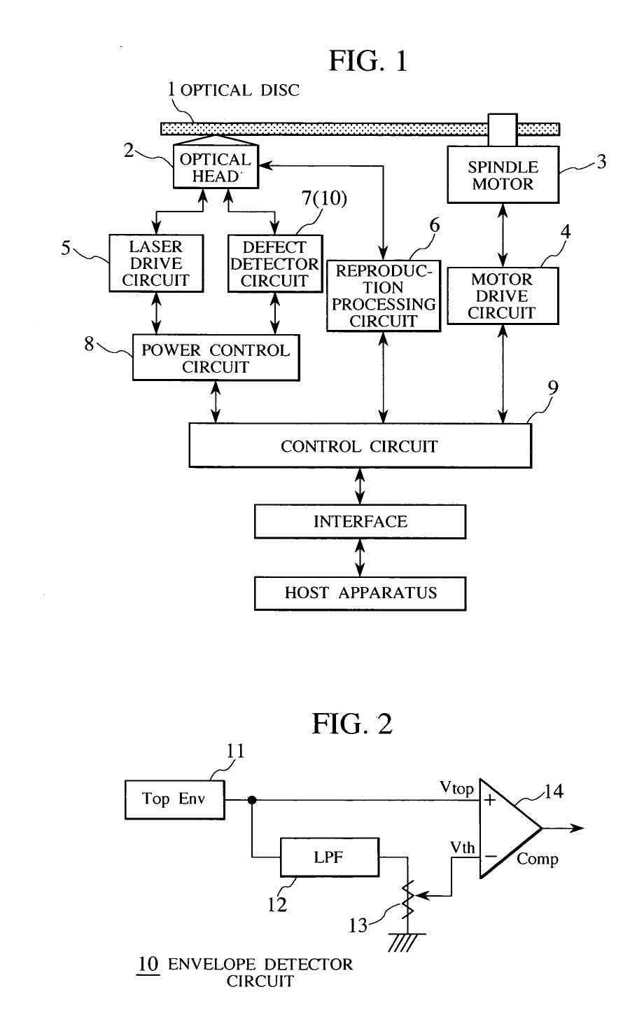

FIG. 2 is a diagram showing the configuration of an envelope detector circuit 10 in the defect detector circuit 7 in FIG. 1. A top level detecting device 11 detects the top envelope value Vtop of a reproduction waveform. An LPF 12 is a low-pass filter with a large time constant, which detects a time-mean level of the top envelope value and obtains a threshold value Vth for defect detection by dividing the voltage level by use of a resistor 13. In other words, the LPF 12 sets a threshold value Vth between the time-mean level at the envelope's top value and the time-mean level at the envelope's bottom value. A comparator 14 compares the top value Vtop with the threshold value Vth. As a result of comparison, if Vtop>Vth, “disc normal” is determined; and if Vtop<Vth, “disc defective” is determined.

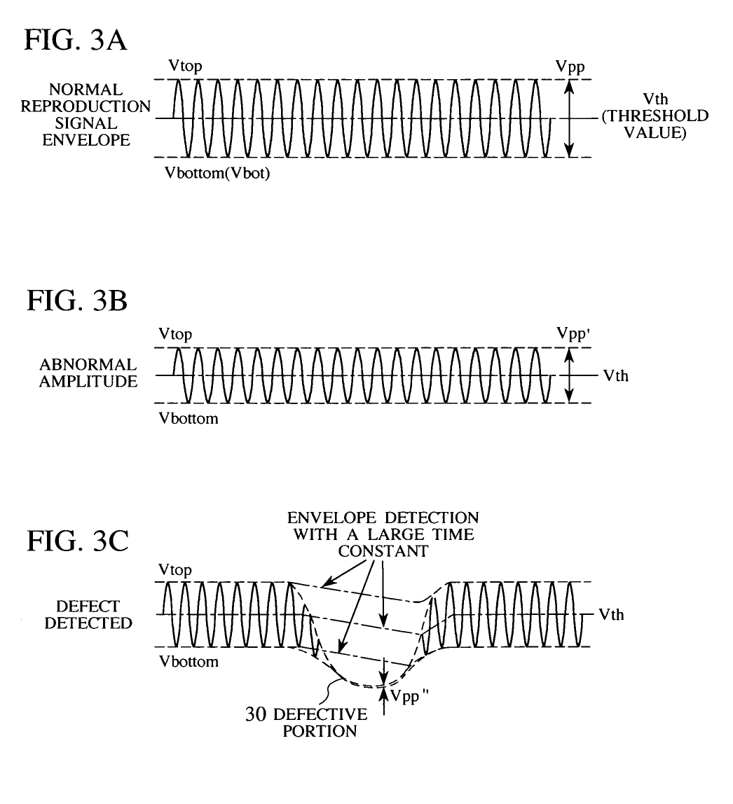

FIG. 3A to FIG. 3C are schematic diagrams showing a defect detecting method for envelope waveform of a reproduction signal in the present embodiment.

FIG. 3A is a diagram showing the envelope of a normal reproduction signal, which is obtained when the top value Vtop and bottom value Vbot of the envelope are stabilized to a constant level. The amplitude value Vpp (difference between Vtop and Vbot) is also constant.

FIG. 3B is a diagram showing a reproduction signal with a constant envelope shape and amplitude value Vpp′ which is smaller than the normal amplitude value (amplitude abnormal). This is caused by inappropriate recording conditions (for example, insufficient recording power). It is necessary to perform trial write processing of a test signal with recording power variations to obtain optimum recording conditions. In accordance with the above-mentioned detector circuit 10 in FIG. 2, the result of comparison of the top value Vtop with the threshold value Vth is Vtop>Vth with respect to the decrease only in the amplitude Vpp.

FIG. 3C is a diagram showing a reproduction signal containing a defect in the envelope. Reference numeral 30 denotes a defective portion where, for example, the amplitude Vpp is sharply reduced to almost zero, Vpp″. If such a no-signal portion occurs, where the amplitude is sharply reduced, the level of the top value Vtop underruns the threshold level Vth resulting in Vtop<Vth. A presumed cause of this is a disc defect (foreign material or flaw). The levels of the amplitude Vpp and top value Vtop are attenuated to zero or several ten percent of the level under normal conditions depending on the degree of the defect. Therefore, the level of the threshold value Vth for defect detection is set as required between the time-mean level at the envelope's top value and the time-mean level at the envelope's bottom value obtained through envelope detection with a large time constant so that a desired detection sensitivity be obtained. If the cause is such a disc defect, the recording quality cannot be improved even by changing (increasing) the recording power.

Thus, the envelope detector circuit in FIG. 2 makes it possible to determine whether the cause of error occurrence is an inappropriate recording power or a disc defect by comparing the top value Vtop with the threshold value Vth through the method shown in FIG. 3A to FIG. 3C.

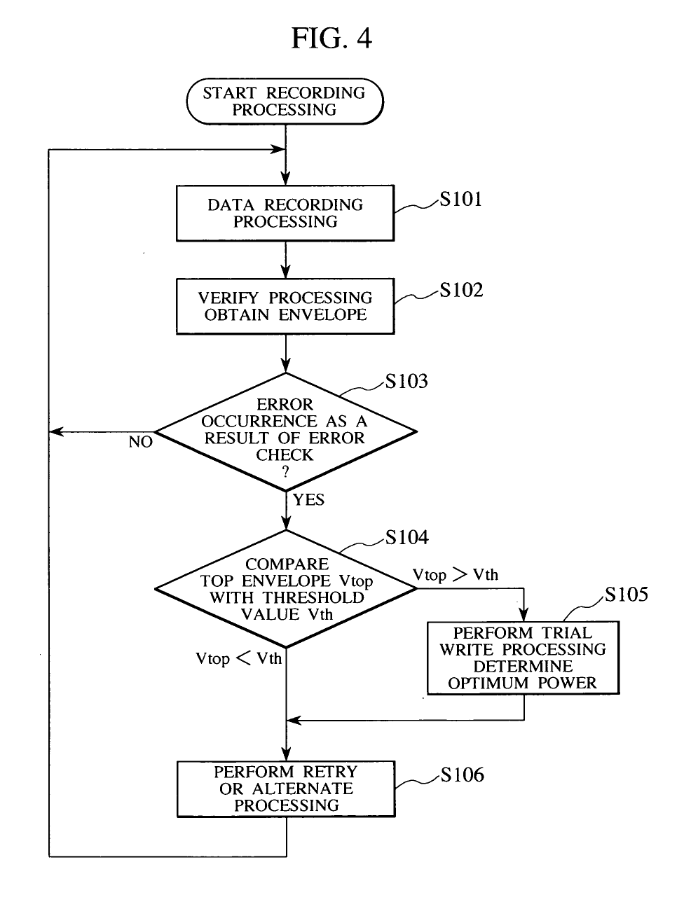

FIG. 4 is a flow chart showing the procedure of recording processing according to the present embodiment. Step S101 performs recording processing for an optical disc with a specified recording power of data. Step S102 obtains an envelope of the reproduction signal by use of the defect detector circuit 7 in order to check whether the data have normally been recorded (verify processing). Step S103 detects an error occurrence through error check by use of the control circuit 9. If an error is not detected, control returns to Step S101 to record the following data.

If an error is detected, Step S104 compares the top level Vtop of the envelope with the threshold value Vth by use of the defect detector circuit 7 (envelope detector circuit 10) in order to judge the cause of the error. If Vtop>Vth, inappropriate recording power is determined and then Step S105 performs trial write processing to obtain an optimum recording power. Then, Step S106 performs the retry recording processing for the data containing a detected error with the optimum recording power or alternate recording processing. If Vtop<Vth in Step S104, a defective disc is determined and then control is transferred to Step S106 without performing trial write processing to perform retry recording processing or alternate recording processing. Subsequently, control returns to Step S101 to repeat the above-mentioned processing for the following data.

In accordance with the present embodiment, it is possible to determine accurately whether an error has been caused by a disc defect or inappropriate power by analyzing the envelope at the time of error occurrence. The trial write processing is performed only in the case of inappropriate power. This makes it possible to reduce unnecessary trial write processing to minimize the degradation of the transfer rate caused by interrupted recording.

Although the above explanation describes a specific example of detector circuit which detects an envelope defect of the reproduction signal through the comparison with the threshold value Vth, the circuit configuration may be set as required taking into account the characteristics of the optical disc and apparatus, not limited to the above-mentioned example.

While we have shown and described embodiment in accordance with our invention, it should be understood that disclosed embodiment is susceptible to changes and modifications without departing from the scope of the invention. Therefore, we do not intend to be bound by the details shown and described herein but intend to cover all such changes and modifications as fall within the ambit of the appended claims.

What is claimed is:

1. An optical disc recording method for recording data on an optical disc, comprising the steps of:
obtaining an envelope of a reproduced signal if an error is detected during reproduction of recorded data; and
performing retry recording or alternate recording of the data containing the detected error without performing trial write processing for optimization of a recording power if there is a defective portion in the envelope, where almost no signal exists.

2. The optical disc recording method for recording data on an optical disc, comprising the steps of:
obtaining an envelope of a reproduced signal if an error is detected during reproduction of recorded data; and
performing retry recording or alternate recording of the data containing the detected error without performing trial write processing for optimization of a recording power if there is a defective portion in the envelope, where the amplitude value is attenuated more than a specified value.

3. The optical disc recording method for recording data on an optical disc, comprising the steps of:
comparing a top value Vtop of an envelope of a reproduced signal with a predefined threshold value Vth if an error is detected during reproduction of recorded data; and
performing trial write processing for optimization of a recording power if Vtop>Vth as a result of comparison, or not performing the trial write processing if Vtop<Vth.

4. The optical disc recording method as defined in claim 3, wherein:
the level of the threshold value Vth is set between time-mean level at an envelope's top value and that at an envelope's bottom value.
